(19) United States
(12) Patent Application Publication
(10) Pub. No.: US 2006/0075988 A1
(43) Pub. Date: Apr. 13, 2006

(54) Intake system for an internal combustion engine

(76) Inventors: Thomas Howe, Esslingen (DE); Wolfgang Lewerenz, Weinstadt (DE); Joerg Miroll, Kongen (DE); Berndt Schuetz, Stuttgart (DE)

Correspondence Address: KLAUS J. BACH, 4407 TWIN OAKS DRIVE, MURRYSVILLE, PA, 15668, US

(21) Appl. No.: 11/245,942

(22) Filed: Oct. 7, 2005

(30) Foreign Application Priority Data
Oct. 9, 2004 (DE) 1020049273.5

(51) Int. Cl. F02M 35/02; F02B 77/04

(52) U.S. Cl. 123/198 E

(57) ABSTRACT

In an intake system for an internal combustion engine having an air filter with a fresh-air line opening into the fresh-air side of the air filter and a clean-air line leading from a clean-air side of the air filter to the internal combustion engine, an additional line which is in communication with the engine compartment extends into the fresh-air side of the air filter starting from the engine compartment, so as to be tapered in the direction toward the clean air side of the air filter with the inlet opening of the additional line being directed toward the adjacent passenger compartment.

### BACKGROUND OF THE INVENTION

The invention relates to an intake system for an internal combustion engine, with an air intake line extending to an inlet side of an air filter and with a clean-air line leading from the clean-air side of the air filter to the internal combustion engine.

Such an intake system is disclosed in, for example, DE 100 34 479 A1. In this case, the intake system has a plurality of branches so as to receive combustion air from various points, in addition to the main air intake. The intention thereby is to dampen the intake noise in the passenger compartment or influence the characteristics of the noise in the vehicle interior. However, this is possible only to a limited extent with the arrangement described.

An air intake system with a primary and a secondary intake line is described in DE 87 15 030 U1. In this case, it is possible, for example if the opening of the primary intake line is clogged with snow, dirt or the like, to switch over to the secondary intake line by means of a flap.

A similar system, but which can be operated without a switch-over flap, is described in DE 44 08 097 A1.

With these arrangements however the noise produced by the internal combustion engine and transmitted into the passenger compartment cannot be influenced.

Various devices which inform the driver acoustically about the operating state of the internal combustion engine, are described in DE 44 35 296 A1 and DE 197 04 376 A1.

It is the object of the present invention to provide an intake system for an internal combustion engine which makes it possible, by simple means, to transmit the intake noise produced by the internal combustion engine into the passenger compartment in a specific manner.

### SUMMARY OF THE INVENTION

In an intake system for an internal combustion engine including an air filter with a fresh-air line opening into the fresh-air side of the air filter and a clean-air line leading from a clean-air side of the air filter to the internal combustion engine, an additional line which is in communication with the engine compartment extends into the fresh-air side of the air filter starting from the engine compartment, so as to be tapered in the direction of the clean air side of the air filter with the inlet opening of the additional line being directed toward the adjacent passenger compartment.

By means of the tapered structure of the at least one additional line, a considerably improved sound radiation to outside the air filter is produced, with the result that the hitherto necessary amplification elements can be omitted.

Furthermore, the arrangement according to the invention, which is unfavorable in terms of flow, ensures that, in normal operation of the internal combustion engine, most of the air introduced is sucked in via the fresh-air line and is sucked in via the additional line only in the event of a possible clogging of the fresh-air line.

In particular if the intake opening of the fresh-air line is clogged with snow or ice, the air which is sucked in via the additional line from the engine compartment is therefore pre-heated and can accelerate the thawing of the snow or of the ice. It is therefore ensured that the full power is available for the internal combustion engine within a relatively short time.

The air flow to the engine through the additional line can be improved, in an advantageous embodiment of the invention, if the additional line opens into the fresh-air side of the air filter in such a manner that the flow within the additional line is directed at least approximately counter to the flow within the fresh-air line.

The invention also resides in a motor vehicle with an internal combustion engine and an intake system according to the invention.

The invention will become more readily apparent from the following description of an exemplary embodiment thereof described below in greater detail with reference to the accompanying drawings.

### BRIEF DESCRIPTION OF THE DRAWINGS

FIG. 1 is plan view of the intake system according to the invention; and

FIG. 2 shows a section through the air filter of the intake system according to the invention.

### DESCRIPTION OF A PARTICULAR EMBODIMENT

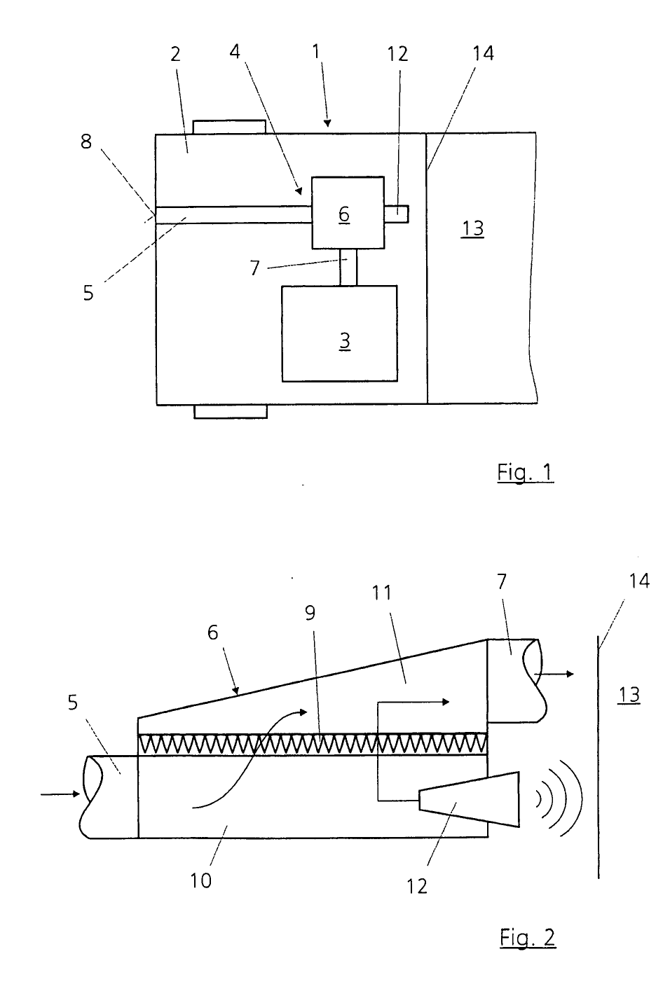

FIG. 1 illustrates in a highly diagrammatic form a motor vehicle 1 with an internal combustion engine 3 arranged in an engine compartment 2 of the motor vehicle. The internal combustion engine 3 has an intake system 4 with a fresh air supply line 5, an air filter 6 and a clean-air line 7. In this case, the fresh-air line 5 extends between an intake opening 8 and the air filter 6 and the clean-air line 7 extends from the air filter 6 to the internal combustion engine 3. The arrangement of the individual components is to be seen as purely diagrammatic and it is entirely customary to arrange the air filter 6 on the internal combustion engine 3.

The air filter 6 of the intake system 4 is illustrated in more detail in FIG. 2. The air filter 6 has a filter element 9 which divides the air filter 6 into a fresh-air side 10, into which the fresh-air line 5 opens, and into a clean-air side 11, to which the clean-air line 7 is connected. The filter element 9 serves in a manner known to filter the intake air flowing into the air filter 6 via the intake-air line 5 in order to be able to supply air which is as clean as possible to the internal combustion engine 3.

It can furthermore be seen in FIG. 2 that an additional line 12, which is in communication with the engine compartment 2 opens into the fresh-air side 10 of the air filter 6 approximately at the side opposite the opening of the fresh-air line 5. The internal combustion engine 3 can likewise suck in air via the additional line 12, but the additional line 12 is designed in a manner unfavorable in terms of flow such that most of the intake air is sucked in via the fresh-air line 5. In the present case, this is achieved in that the additional line 12 starting from the engine compartment 2 tapers toward the fresh-air side 10 of the air filter 6 and therefore has a certain flow resistance to the air entering therethrough. The additional line 12 is of conical design, with the smaller diameter being situated within the air filter 6. By means of the additional line 12, the sound produced within the air filter 6 by the sucking-in operation can pass to the outside in the direction toward a passenger compartment 13 (illustrated in FIG. 1) of the motor vehicle 1. Disposed between the additional line 12 and the passenger compartment 13 is a partition 14 against which the sound emitted by the air filter 6 impacts. The described conical design of the additional line 12, acts as a diffuser for the sound, so that the sound radiation from the air filter 6 is improved.

A further function of the additional line 12 is that it constitutes an additional inlet into the air filter 6 in those situations when the intake opening 8 of the clean-air line 7 is clogged with snow or ice. In this case, the air heated, for example, by the exhaust system (not illustrated) of the internal combustion engine 3 is conducted or sucked via the additional line 12 from the engine compartment 2 into the air filter 6, which leads, on account of the higher temperature of the air in the engine compartment 2, to a melting of the snow or ice. As soon as the intake opening 8 is freed in this manner from snow or ice, the more favorable flow conditions prevailing there result in the air which is supplied to the internal combustion engine 3 being sucked in essentially only via the fresh-air line 5. The possible flows within the air filter 6 are indicated in FIG. 2 by means of arrows.

The noise radiation is dependent on the power and the rotational speed of the internal combustion engine 3 and generates a sporty sound emphasizing the power of the engine in the passenger compartment 13. This sound can be influenced or tuned by changing the length and/or the cross section of the additional line 12. For this purpose, among other things, the length of the additional line 12 within the air filter 6 can be changed, which leads to a transmission of different frequencies. The shape of the additional line 12 is a compromise between a small throughput quantity by the same and a good radiation performance for the sound generated in the air filter 6. Furthermore, the heat supplied in the direction of the intake opening 8 is also influenced by the length of the additional line 12 within the air filter 6. In the present case, the additional line 12 extends partially within and partially outside the air filter 6. It would also be possible, in a manner not illustrated, for the additional line 12 to be disposed entirely within or entirely outside the air filter 6. The greater the amount of the additional line 12 that is disposed within the air filter 6, the smaller is the construction space taken up by the same in the engine compartment 2.

The additional line 12 opens into the fresh-air side 10 in such a manner that the flow within the additional line 12 is directed at least approximately counter to the flow within the clean-air line 7. As a result, the hot air entering via the additional line 12 has to be deflected through approx. 180° in order to flow to the internal combustion engine 3. This provides for an arrangement of the additional line 12 which is unfavorable in terms of flow. It would also be possible, in a manner which is not illustrated, for the opening of the additional line 12, which opening faces the air filter 6, to be designed as a venturi nozzle.

The additional line 12 may be produced together with the air filter 6, i.e. the additional line 12 and the air filter 6 may be integrally formed. Furthermore, it is also conceivable to produce the additional line 12 and the air filter 6 separately, the additional line 12 then being connected to the air filter 6, for example by screwing or be another suitable manner of connection.

In the case in which the internal combustion engine 3 is designed in a V-construction, the air filter 6 preferably has two clean-air lines 7 leading to the respective cylinder banks of the internal combustion engine 3. Of course, in this case two fresh-air lines 5 which are independent of each other and accordingly also two additional lines 12 may also be provided. However, it is also possible in all other cases for two or more additional lines 12 to be provided on the air filter 6.

What is claimed is:

1. An air intake system for an internal combustion engine (3) disposed in an engine compartment (2) and including an air filter (6) with a fresh air side (10) and a clean air side (11), a fresh-air line leading to the fresh air side (10) of the air filter (6) and with a clean air line (7) extending from the clean-air side (11) of the air filter (6) to the internal combustion engine (3) and an additional line (12) in communication with the engine compartment (2) and opening into the fresh-air side (10) of the air filter (6), the additional line (12) starting in the engine compartment (2) and tapering down in the direction toward the clean-air side (11) of the air filter (6).

2. The intake system as claimed in claim 1, wherein the additional line (12) opens into the fresh-air side (10) of the air filter (6) at least approximately opposite the opening of the fresh-air line (5) into the fresh air side (10) of the air filter (6).

3. The intake system as claimed in claim 1, wherein the additional line (12) opens into the fresh-air side (10) of the air filter (6) in such a manner that the flow within the additional line (12) is at least approximately directed counter to the air flow through the clean-air line (7).

4. The intake system as claimed in claim 1, wherein the additional line (12) extends at least over part of its length within the fresh-air side (10) of the air filter (6).

5. The intake system as claimed in claim 1, wherein the additional line (12) has a discharge end that projects into the fresh-air side (10) of the air filter (6) and which is in the form of a venturi tube.

6. The intake system as claimed in claim 1, wherein the air filter (6) includes a filter element (9) separating the fresh-air side (10) from the clean-air side (11).

7. The intake system as claimed in claim 1, wherein the additional line (12) is formed integrally with the air filter (6).

8. The intake system as claimed in claim 1, wherein the additional line (12) is a separate component and is connected to the air filter (6).

9. A motor vehicle with an internal combustion engine (3) and with an intake system for the internal combustion engine (3), said engine disposed in an engine compartment (2) and including an air filter (6) with a fresh air side (10) and a clean air side (11), a fresh-air line leading to the fresh air side (10) of the air filter (6) and with a clean air line (7) extending from the clean-air side (11) of the air filter (6) to the internal combustion engine (3) and an additional line (12) in communication with the engine compartment (2) and opening into the fresh-air side (10) of-the air filter (6), the additional line (12) starting in the engine compartment (2) and tapering down in the direction toward the clean-air side (11) of the air filter (6).
